(19) United States
(12) Patent Application Publication
(10) Pub. No.: US 2012/0111647 A1
(43) Pub. Date: May 10, 2012

(54) APPARATUS FOR WEIGHING A PERSON

(76) Inventor: Ralf LINDNER, Duesseldorf (DE)

(21) Appl. No.: 13/017,993

(22) Filed: Jan. 31, 2011

(30) Foreign Application Priority Data
Nov. 5, 2010 (DE) 102010050332.0

(51) Int. Cl. G01G 19/44; G01G 21/28

(52) U.S. Cl. 177/238

(57) ABSTRACT

A personal scale has a housing having a generally horizontal upper platform wall adapted to be stood on by a person, and formed with a central boss shaped having sloped side surfaced angled to fit the longitudinal arch or instep of a person standing on the platform. An evaluating/display unit in the housing determines and displays the weight of the person standing on the platform.

### FIELD OF THE INVENTION

The present invention relates to an apparatus for weighing a person. More particularly this invention concerns a personal scale.

### BACKGROUND OF THE INVENTION

A typical personal scale comprises a flat casing adapted to sit on the floor, a flat cover forming a platform on top of the case on top of which a person is intended to stand, and means inside for detecting the weight of the person on the platform and displaying it. Such a scale is generally known and part of the usual equipment of a bathroom because in the bathroom, the average citizen frequently checks his/her weight in connection with his/her body care.

In case of typical body weight scales it is considered to be disadvantageous that from an ergonomic point of view they are not comfortable to stand on.

### OBJECTS OF THE INVENTION

It is therefore an object of the present invention to provide an improved personal scale.

Another object is the provision of such an improved personal scale that overcomes the above-given disadvantages, in particular that is adapted to the shape of the feet, in particular bare feet.

### SUMMARY OF THE INVENTION

A personal scale has according to the invention a housing having a generally horizontal upper platform wall adapted to be stood on by a person, and formed with a central boss shaped having sloped side surfaced angled to fit the longitudinal arch or instep of a person standing on the platform. An evaluating/display unit in the housing determines and displays the weight of the person standing on the platform.

Thus the central part of the top wall or platform of the scale, which is adapted to fit between the feet of the person who is using the scale, has inclined surfaces that support the longitudinal arches of the feet. The result is that the user inherently centers himself or herself on the scale. Since the scale typically has a number of feet each with a respective strain gauge and the outputs of all the strain gauges are used to determine the weight of the person, a more accurate result is obtained when the person is centered on the scale.

The scale according to the invention also has the advantage that the central elevation in the stand area of the apparatus for weighing persons results in an advantageous support of the feet in the region of the longitudinal arch. This, in particular for elderly persons, allows not only for a secure, but also comfortable footing on the scale.

In an advantageous embodiment of the invention, the central elevation has a circular shape. It can also be oval.

Finally, a further embodiment of the invention has a display in the platform in the region of the central elevation. As a result, the space on the scale that is usually between the feet during standing is utilized in a particularly space-saving and advantageous manner.

### BRIEF DESCRIPTION OF THE DRAWING

The above and other objects, features, and advantages will become more readily apparent from the following description, reference being made to the accompanying drawing in which:

FIG. 1 is a top view of a personal scale with a user's feet shown in outline;

FIG. 2 is a section taken along line II-II of FIG. 1;

FIG. 3 is a simplified top view of the scale; and

FIG. 4 is a plan view of another embodiment of the scale.

### SPECIFIC DESCRIPTION

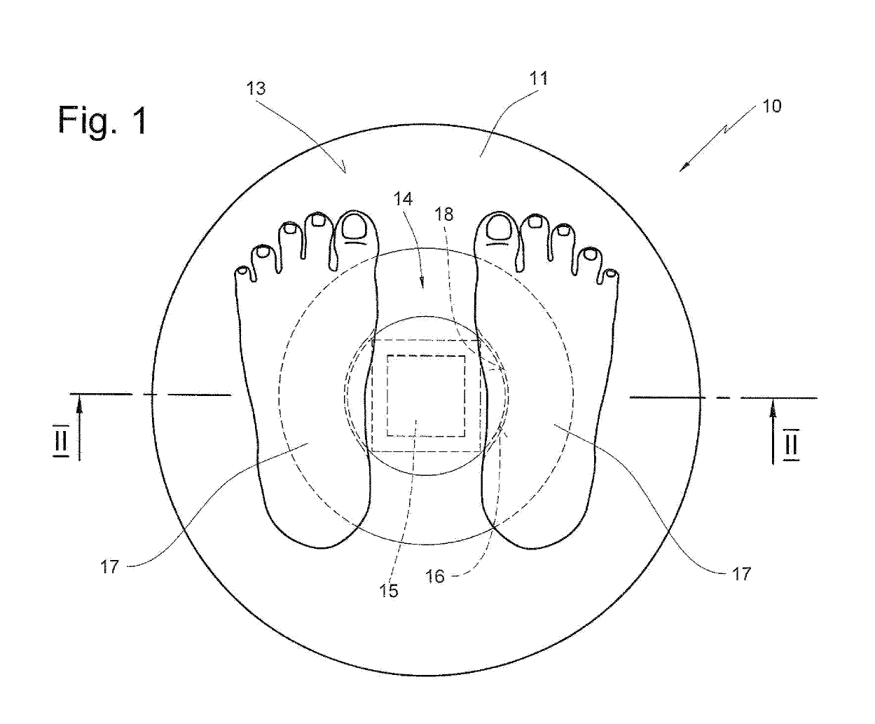

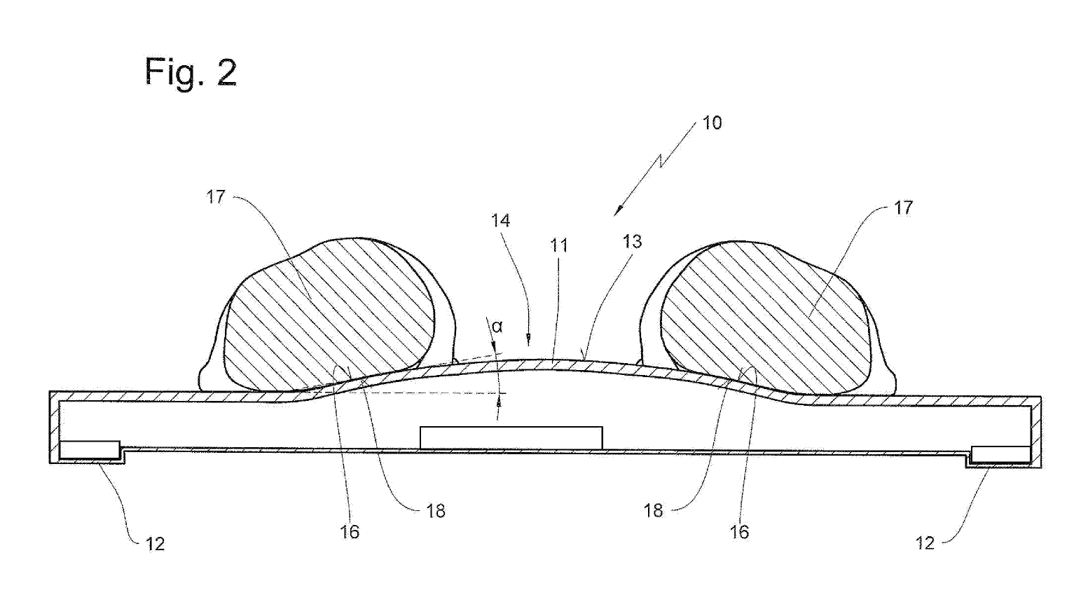

As seen in FIGS. 1-2 a personal scale 10 has a base or housing 12 adapted to sit on the floor and having an upper wall or cover 11 forming an upper platform surface 13. The circular platform 13 in the present illustrated embodiment is provided with a central elevation 14 carrying a central display 15. The central elevation 14 is provided along its outer edge with inclined surfaces 16 that serve as supports for the longitudinal arches or insteps of feet 17.

Internally the housing 12 has strain-gauge sensors 20 that can detect the weight of the person standing on the platform 13, and electronic controller 20 connected with the display for displaying the person's weight, or the difference between the person's weight and a desired weight previously stored in a memory of the controller 20.

FIG. 2 in particular shows that the inclined surfaces 16 rest complementarily against the surfaces 18 of the longitudinal arches of the feet 17 and thus support them over a large area during standing on the apparatus 10 for weighing. The inclination angle a of the inclined surfaces 16 should principally be adapted to the form of the longitudinal arch of an average foot of a person, and theoretically an adaptation of the inclination angle and of the form of the central elevation to actual feet of a person is also possible.

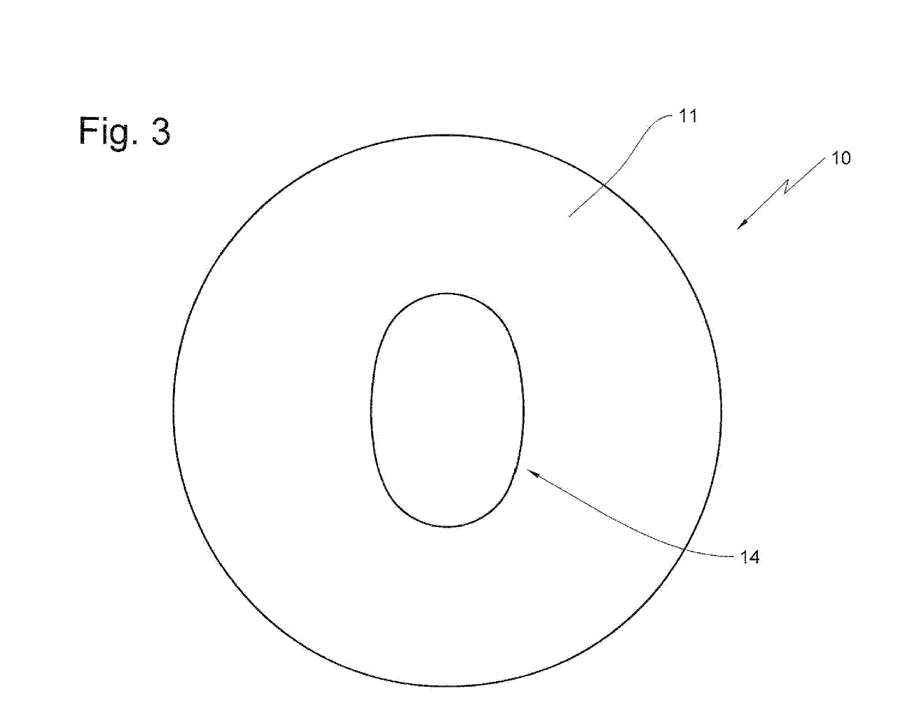

FIG. 3 shows a plan view of one of the many conceivable modifications of the central elevation 14, where the central elevation 14 has an oval shape.

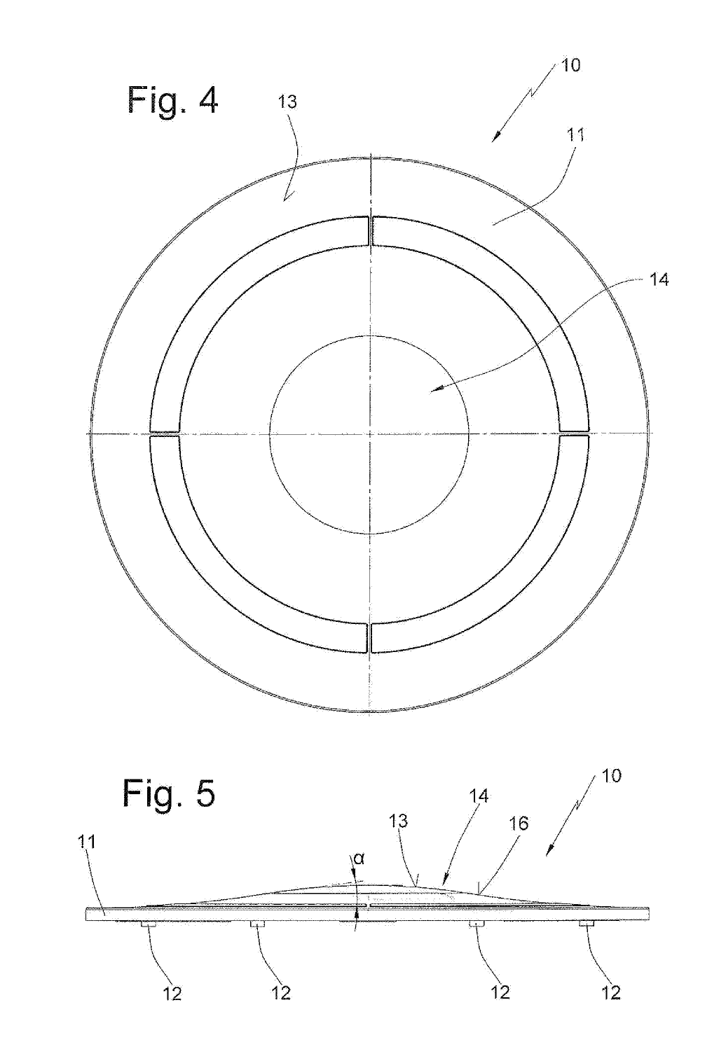

Finally, FIG. 4 illustrates an embodiment of the apparatus 10 for weighing persons which overall has a central elevation 14, but is very flat.

I claim:

1. A personal scale comprising:
a housing having a generally horizontal upper platform wall adapted to be stood on by a person, and formed with a central boss shaped having sloped side surfaced angled to fit the longitudinal arch or instep of a person standing on the platform; and
means in the housing for determining and displaying the weight of the person standing on the platform.

2. The personal scale defined in claim 1, wherein the central boss is substantially circular.

3. The personal scale defined in claim 1, wherein the central boss is generally oval.

4. The personal scale defined in claim 1 wherein the means includes a display on the central boss.
